(19) United States
(12) Patent Application Publication
(10) Pub. No.: US 2021/0245616 A1
(43) Pub. Date: Aug. 12, 2021

(54) CHARGE/DISCHARGE DEVICE AND CHARGE/DISCHARGE SYSTEM

(71) Applicant: MITSUBISHI ELECTRIC CORPORATION, Tokyo (JP)

(72) Inventor: Takao KONISHI, Tokyo (JP)

(73) Assignee: Mitsubishi Electric Corporation, Tokyo (JP)

(21) Appl. No.: 16/607,240

(22) PCT Filed: Oct. 23, 2018
(86) PCT No.: PCT/JP2018/039348

§ 371 Date: Oct. 22, 2019

(51) Int. Cl. B60L 53/53; B60L 53/62; B60L 53/67; B60L 55/00; H02J 3/32; H02J 7/34; H02J 7/00

(52) U.S. Cl. CPC B60L 53/53; B60L 53/62; B60L 53/67; B60L 55/00; H02J 2310/12; H02J 7/342; H02J 7/0068; H02J 7/0047; H02J 2310/48; H02J 3/322

(57) ABSTRACT

A charge/discharge device according to the present invention is an electric-vehicle charger/discharger that constitutes a charge/discharge system together with a storage-battery charger/discharger that performs an operation of charging a storage battery installed in a house and an operation of discharging the stationary storage battery to supply electric power to a household load, and performs an operation of charging a storage battery for power included in an electric vehicle and a discharging operation of discharging the storage battery for power to supply electric power to the household load, and the charge/discharge device includes a current detection unit to detect a value of a current that flows between the storage battery and the household load, and a control unit to control the operation of charging the storage battery for power and the operation of discharging the storage battery for power based on a value of a current detected by the current detection unit.

### FIELD

The present invention relates to a charge/discharge device and a charge/discharge system that are used while being connected with a storage battery for power incorporated in an electric vehicle or the like.

### BACKGROUND

In recent years, there are an increasing number of homes that bring in equipment for charging a storage battery for power along with the spread of vehicles provided with an electric motor and the storage battery for power that stores therein electric power to be supplied to the electric motor, such as electric vehicles. A charge/discharge device has also become popular which can not only charge the storage battery for power but also can discharge electric power stored in the storage battery for power to supply the electric power to domestic devices in a case where a power failure occurs in a system power supply, for example.

Further, a charge/discharge system has also become popular in which a stationary storage battery that is different from a storage battery for power incorporated in a vehicle is installed in a house, surplus power of electric power obtained by a photovoltaic system or the like is stored in the storage battery, and the storage battery is discharged to supply electric power to domestic devices in a case of power shortage, for example.

There is a case where both a charge/discharge device that enables supply of electric power from a storage battery for power to domestic devices and a charge/discharge device that enables supply of electric power from a storage battery installed in a house to domestic devices as those described above are used together (see, for example, Patent Literature 1).

In the invention described in Patent Literature 1, a first charge/discharge control device for a storage battery for power (a first storage battery) of an electric vehicle and a second charge/discharge control device for a stationary storage battery (a second storage battery) installed in a building are used together, where the first charge/discharge control device determines an operation of the second charge/discharge control device based on a current from the second charge/discharge control device to a power system, and controls charging/discharging of the first storage battery in accordance with the operation of the second charge/discharge control device.

### CITATION LIST

### Patent Literature

Patent Literature 1: Japanese Patent Application Laid-open No. 2017-22860

### SUMMARY

### Technical Problem

Although Patent Literature 1 describes a method of preventing occurrence of abnormal charge/discharge, it fails to describe a method of preventing transfer of electric power between a storage battery for power and a stationary storage battery, that is, a method of preventing transfer of electric power from the storage battery for power to the stationary storage battery, or from the stationary storage battery to the storage battery for power. For example, in a case where transfer of electric power occurs in such a manner that a storage battery for power is discharged in the daytime and a stationary storage battery is charged, direct-current to alternating-current conversion and alternating-current to direct-current conversion are performed. In this case, there is a problem that loss of electric power is generated depending on the efficiency of electric-power conversion.

The present invention has been achieved in view of the above problems, and an object of the present invention is to provide a charge/discharge device capable of preventing transfer of electric power between a storage battery for power included in an electric vehicle and a stationary storage battery, thereby suppressing loss in association with transfer of electric power.

### Solution to Problem

In order to solve the problem described above and achieve the object, in a charge/discharge device to constitute a charge/discharge system together with a storage-battery charger/discharger that performs an operation of charging a stationary storage battery installed in a house and an operation of discharging the stationary storage battery to supply electric power to a load, and to perform an operation of charging a storage battery for power included in an electric vehicle and a discharging operation of discharging the storage battery for power to supply electric power to the load, the charge/discharge device of the present invention includes: a current detection unit to detect a value of a current that flows between the stationary storage battery and the load; and a control unit to control the operation of charging the storage battery for power and the operation of discharging the storage battery for power based on a value of a current detected by the current detection unit.

### Advantageous Effects of Invention

The charge/discharge device according to the present invention has an effect where it is possible to prevent transfer of electric power between a storage battery for power included in an electric vehicle and a stationary storage battery, thereby suppressing loss of electric power.

### BRIEF DESCRIPTION OF DRAWINGS

FIG. 1 is a diagram schematically illustrating a charge/discharge system according to a first embodiment.

FIG. 2 is a diagram illustrating a configuration example of the charge/discharge system according to the first embodiment.

FIG. 3 is a diagram illustrating an example of functions implemented by a microcomputer provided in an electric-vehicle charger/discharger according to the first embodiment.

FIG. 4 is a diagram illustrating a first example when electric power is transferred between storage batteries.

FIG. 5 is a diagram illustrating a second example when electric power is transferred between storage batteries.

FIG. 6 is a flowchart illustrating an operation example of determining another device connected to a power line performed by the electric-vehicle charger/discharger according to the first embodiment.

FIG. 7 is a flowchart illustrating an example of a charge control operation of the electric-vehicle charger/discharger according to the first embodiment.

FIG. 8 is a flowchart illustrating an example of a discharge control operation of the electric-vehicle charger/discharger according to the first embodiment.

FIG. 9 is a diagram schematically illustrating a configuration example of a charge/discharge system according to a second embodiment.

FIG. 10 is a diagram illustrating a configuration example of the charge/discharge system according to the second embodiment.

FIG. 11 is a diagram illustrating a functional configuration example of a control device that constitutes the charge/discharge system according to the second embodiment.

FIG. 12 is a flowchart illustrating an operation example of the control device that constitutes the charge/discharge system according to the second embodiment.

FIG. 13 is a flowchart illustrating an operation example of an electric-vehicle charger/discharger according to the second embodiment.

FIG. 14 is a diagram illustrating a modification of the charge/discharge system according to the second embodiment.

### DESCRIPTION OF EMBODIMENTS

A charge/discharge device and a charge/discharge system according to embodiments of the present invention will be described in detail below with reference to the accompanying drawings. The present invention is not limited to the embodiments.

### First Embodiment

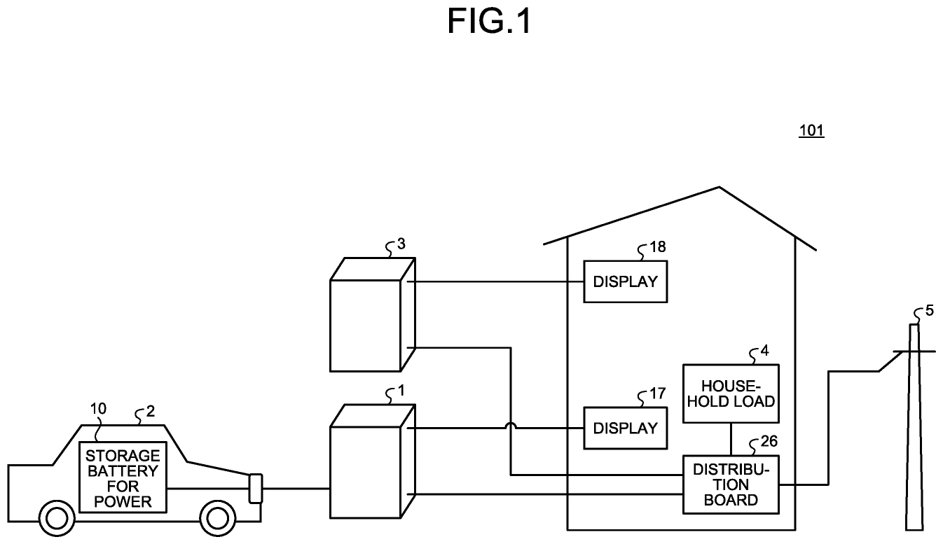

FIG. 1 is a diagram schematically illustrating a charge/discharge system according to a first embodiment. A charge/discharge system 101 illustrated in FIG. 1 includes an electric-vehicle charger/discharger 1 that is a charge/discharge device according to the first embodiment, an electric vehicle 2 having a storage battery 10 for power incorporated therein, and a storage-battery charger/discharger 3 that is a charger/discharger for a stationary storage battery.

The electric-vehicle charger/discharger 1 is a first charger/discharger. The electric-vehicle charger/discharger 1 is connected to a display 17 and a distribution board 26. Further, the electric-vehicle charger/discharger 1 is connectable to the storage battery 10 for power. FIG. 1 illustrates a state where the electric-vehicle charger/discharger 1 and the storage battery 10 for power are connected to each other.

The storage-battery charger/discharger 3 is a second charger/discharger. The storage-battery charger/discharger 3 is connected to a display 18 and the distribution board 26. A domestic load, that is, a household load 4 that is one of various types of devices installed in a house, and a system power supply 5 are connected to the distribution board 26.

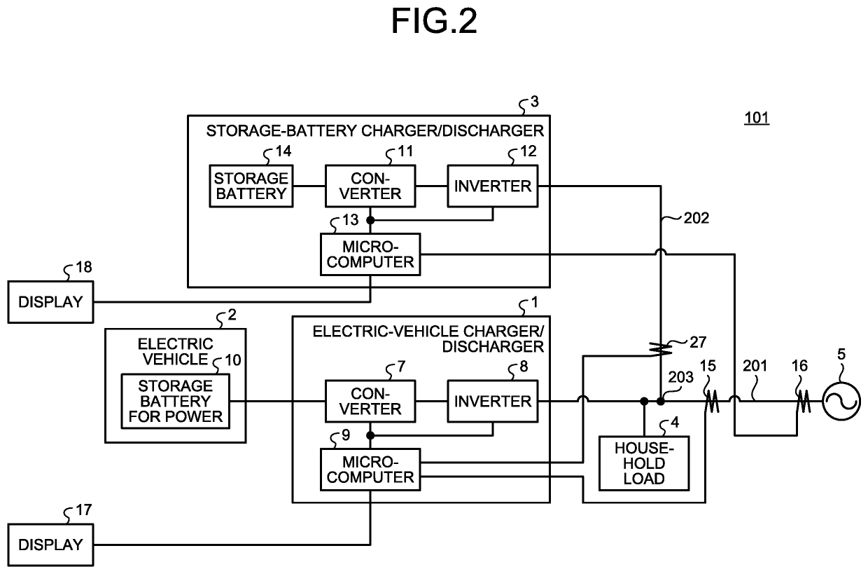

FIG. 2 is a diagram illustrating a configuration example of the charge/discharge system 101 according to the first embodiment. Among the respective constituent elements illustrated in FIG. 2, constituent elements identical to those illustrated in FIG. 1 are denoted by like reference signs. In FIG. 2, illustrations of the distribution board 26 illustrated in FIG. 1 are omitted.

As illustrated in FIG. 2, the electric-vehicle charger/discharger 1 includes a converter 7, an inverter 8, and a microcomputer 9 that is a microprocessor, and is used while being connected to the storage battery 10 for power included in the electric vehicle 2. The storage-battery charger/discharger 3 includes a converter 11, an inverter 12, a microcomputer 13, and a storage battery 14. The storage battery 14 is a stationary storage battery. Although FIG. 2 illustrates the configuration example in which the storage-battery charger/discharger 3 includes the storage battery 14, a configuration may be employed in which the storage battery 14 is provided outside the storage-battery charger/discharger 3. Current sensors 15 and 27 and the display 17 are connected to the microcomputer 9 of the electric-vehicle charger/discharger 1. A current sensor 16 and the display 18 are connected to the microcomputer 13 of the storage-battery charger/discharger 3.

When the storage battery 10 for power is discharged, a direct-current voltage output from the storage battery 10 for power is input to the electric-vehicle charger/discharger 1. The electric-vehicle charger/discharger 1 performs voltage conversion by the converter 7 for the voltage input thereto in a form of direct current, further performs direct-current to alternating-current conversion by the inverter 8, and outputs the converted voltage.

The microcomputer 9 of the electric-vehicle charger/discharger 1 controls the converter 7 and the inverter 8. The microcomputer 9 also controls the display 17. Further, the microcomputer 9 detects a direction of a current that flows through a power line 201 that connects the system power supply 5 and the household load 4 to each other, that is, detects whether a current flows from the system power supply 5 to the household load 4 or flows in the opposite direction by using the current sensor 15 provided in the power line 201. The direction from the system power supply 5 to the household load 4 is an electricity-buying direction, and the direction from the household load 4 to the system power supply 5 is an electricity-selling direction. The electric-vehicle charger/discharger 1 and the storage-battery charger/discharger 3 are also connected to the power line 201. The current sensor 15 is arranged at a position between a connecting point 203 of the storage-battery charger/discharger 3 and the system power supply 5. Further, the current sensor 15 constitutes a first electric-power detection unit.

The microcomputer 9 recognizes the amount of a current that flows through the power line 201 in the electricity-buying direction and the amount of a current that flows through the power line 201 in the electricity-selling direction. The electric-vehicle charger/discharger 1 performs discharging to minimize electric power bought from the system power supply 5 and supplies electric power to the household load 4, for example. Further, the microcomputer 9 recognizes a direction and the amount of a current that flows through an electric-power line 202 that connects the storage-battery charger/discharger 3 and the power line 201, by using the current sensor 27 provided in the electric-power line 202. The display 17 connected to the microcomputer 9 also serves as an input device that receives an operation from a user. The display 17 implements a user interface unit that is used when the user monitors an operation state and when the user changes an operation mode, for example.

In a case where the storage battery 14 included in the storage-battery charger/discharger 3 is discharged, a direct-current voltage output from the storage battery 14 is subjected to voltage conversion by the converter 11 in a form of direct current, is then subjected to direct-current to alternating-current conversion by the inverter 12, and is thereafter output.

The microcomputer 13 of the storage-battery charger/discharger 3 controls the converter 11 and the inverter 12. The microcomputer 13 also controls the display 18. Further, the microcomputer 13 detects a direction of a current that flows through the power line 201 that connects the system power supply 5 and the household load 4 to each other, by using the current sensor 16 provided in the power line 201. The current sensor 16 is arranged at a position between the connecting point 203 of the storage-battery charger/discharger 3 and the system power supply 5. The display 18 connected to the microcomputer 13 also serves as an input device that receives an operation from a user, as with the display 17 described above. The display 18 is used when the user monitors an operation state and when the user changes an operation mode, for example.

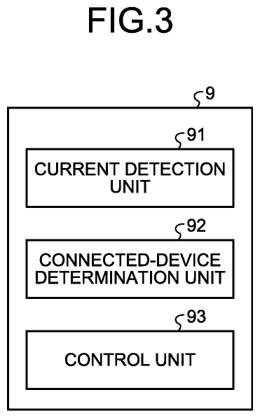

FIG. 3 is a diagram illustrating an example of functions implemented by the microcomputer 9 provided in the electric-vehicle charger/discharger 1 according to the first embodiment. The microcomputer 9 implements a current detection unit 91, a connected-device determination unit 92, and a control unit 93.

The current detection unit 91 detects a value of a current that flows between the system power supply 5 and the household load 4 and a value of a current that flows between the storage-battery charger/discharger 3 and the household load 4. That is, the current detection unit 91 acquires a current value that indicates a value of a current detected by the current sensor 15 from the current sensor 15, and acquires a current value that indicates a value of a current detected by the current sensor 27 from the current sensor 27.

The connected-device determination unit 92 determines whether the storage-battery charger/discharger 3 is connected to the power line 201 based on the value of the current that flows between the storage-battery charger/discharger 3 and the household load 4 detected by the current detection unit 91.

The control unit 93 controls the converter 7, the inverter 8, and the display 17.

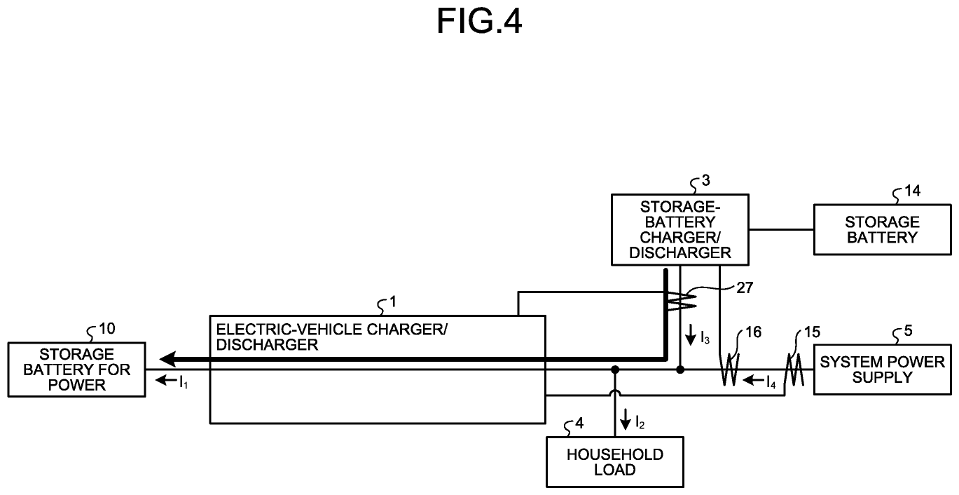

FIG. 4 is a diagram illustrating a first example when electric power is transferred between storage batteries. An arrow of solid line indicates a transfer direction of electric power. FIG. 4 illustrates a case where electric power is transferred from the storage-battery charger/discharger 3 to the electric-vehicle charger/discharger 1. I₁ represents a current that flows between the storage battery 10 for power and the electric-vehicle charger/discharger 1, and I₂ represents a current consumed by the household load 4. I₃ represents a current that flows between the storage-battery charger/discharger 3 and the power line 201, and I₄ represents a current supplied from the system power supply 5.

Transfer of electric power illustrated in FIG. 4 occurs in the following cases A and B. It is assumed that the electric-vehicle charger/discharger 1 does not execute control according to the present invention, which will be described later, but executes control that is identical to conventionally executed control.

(Case A)

Transfer of electric power illustrated in FIG. 4 occurs in a case where the electric-vehicle charger/discharger 1 performs a charging operation in a minimum electricity-buying mode and the storage-battery charger/discharger 3 performs a discharging operation in a minimum electricity-buying mode. The charging operation in the minimum electricity-buying mode performed by the electric-vehicle charger/discharger 1 is an operation of minimizing the amount of electricity bought from the system power supply 5 and charging the storage battery 10 for power with surplus power when the surplus power is generated. The discharging operation in the minimum electricity-buying mode performed by the storage-battery charger/discharger 3 is an operation of discharging the storage battery 14 and supplying electric power to the household load 4 in such a manner that the amount of electricity bought from the system power supply 5, that is, the amount of electric power supplied from the system power supply 5 is minimized.

In the case A, when the current value I₃ that represents a discharged current from the storage-battery charger/discharger 3 is larger than the current value I₂ of a current consumed by the household load 4, the surplus current is the current value I₁ and the storage battery 10 for power is charged. That is, the electric-vehicle charger/discharger 1 and the storage-battery charger/discharger 3 operate in such a manner that the expression (1) is established.

I₁=I₃−I₂+I₄ (1)

However, because the electric-vehicle charger/discharger 1 and the storage-battery charger/discharger 3 operate to minimize the amount of bought electricity, the current value I₄ from the system power supply 5 is approximately 0. At this time, the electric-vehicle charger/discharger 1 determines electric power discharged from the storage-battery charger/discharger 3 as surplus power. Meanwhile, the storage-battery charger/discharger 3 cannot distinguish whether the discharged electric power is used for charging the storage battery 10 for power or is consumed by the household load 4. Therefore, charging of the storage battery 10 for power is continued, resulting in transfer of electric power stored in the storage battery 14 to the storage battery 10 for power.

(Case B)

Transfer of electric power illustrated in FIG. 4 occurs in a case where the electric-vehicle charger/discharger 1 performs a charging operation in a forced charging mode and the storage-battery charger/discharger 3 performs the discharging operation in the minimum electricity-buying mode. The charging operation in the forced charging mode performed by the electric-vehicle charger/discharger 1 is an operation of charging the storage battery 10 for power without considering the amount of bought electricity and the like.

In the case B, the current value I₁ that is a charging current to the storage battery 10 for power is constant. Meanwhile, the storage-battery charger/discharger 3 outputs the current value I₃ in such a manner that the current value I₄ of a current supplied from the system power supply 5 becomes 0. At this time, if a current output from the storage-battery charger/discharger 3 (the current value I₃) does not meet the charging current to the storage battery 10 for power (the current value I₁), a shortfall is supplied from the system power supply 5. That is, the electric-vehicle charger/discharger 1 and the storage-battery charger/discharger 3 operate in such a manner that the expression (2) is established.

I₁+I₂=I₃+I₄ (2)

The electric-vehicle charger/discharger 1 continues the charging operation until completion of charging of the storage battery 10 for power. At this time, the storage-battery charger/discharger 3 continues the discharging operation because it cannot distinguish whether the discharged electric power is used for charging the storage battery 10 for power or is used by the household load 4. As a result, electric power stored in the storage battery 14 is transferred to the storage battery 10 for power.

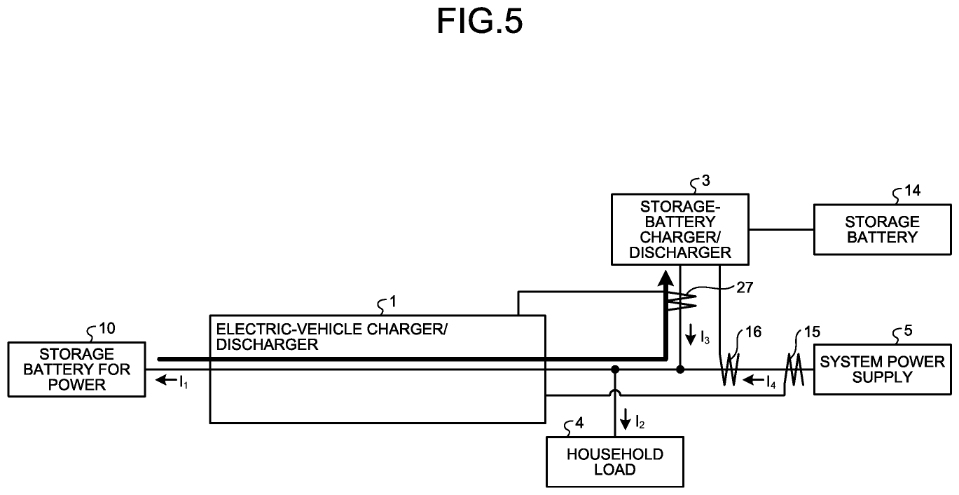

FIG. 5 is a diagram illustrating a second example when electric power is transferred between storage batteries. An arrow of solid line indicates a transfer direction of electric power. FIG. 5 illustrates a case where electric power is transferred from the electric-vehicle charger/discharger 1 to the storage-battery charger/discharger 3. As in FIG. 4, I₁ represents a current that flows between the storage battery 10 for power and the electric-vehicle charger/discharger 1 and I₂ represents a current consumed by the household load 4. I₃ represents a current that flows between the storage-battery charger/discharger 3 and the power line 201 and I₄ represents a current supplied from the system power supply 5.

Transfer of electric power illustrated in FIG. 5 occurs in the following case C. It is assumed that the electric-vehicle charger/discharger 1 does not execute control according to the present invention, which will be described later, but executes control that is identical to conventionally executed control.

(Case C) Transfer of electric power illustrated in FIG. 5 occurs in a case where the electric-vehicle charger/discharger 1 performs a discharging operation in a minimum electricity-buying mode and the storage-battery charger/discharger 3 performs a charging operation in a forced charging mode. The discharging operation in the minimum electricity-buying mode performed by the electric-vehicle charger/discharger 1 is an operation of discharging the storage battery 10 for power and supplying electric power to the household load 4 in such a manner that the amount of electricity bought from the system power supply 5 is minimized. The charging operation in the forced charging mode performed by the storage-battery charger/discharger 3 is an operation of charging the storage battery 14 without considering the amount of bought electricity and the like.

In the case C, the current value I₃ that is a charging current to the storage battery 14 is constant. Meanwhile, the electric-vehicle charger/discharger 1 discharges the storage battery 10 for power and outputs the current value I₁ in such a manner that the current value I₄ of a current supplied from the system power supply 5 becomes 0. At this time, if the current value I₁ output from the electric-vehicle charger/discharger 1 does not meet a charging current to the storage battery 14 (the current value I₃), a shortfall is supplied from the system power supply 5. That is, the electric-vehicle charger/discharger 1 and the storage-battery charger/discharger 3 perform operations in such a manner that the expression (3) is established. In the expression (3), the sign “−” represents that a current with this sign flows in the opposite direction to the arrow in FIG. 5.

−I₃=−I₁−I₂+I₄ (3)

The storage-battery charger/discharger 3 continues the charging operation until completion of charging of the storage battery 14. At this time, the electric-vehicle charger/discharger 1 continues the discharging operation because it cannot distinguish whether the discharged electric power is used for charging the storage battery 14 or is used by the household load 4. As a result, electric power stored in the storage battery 10 for power is transferred to the storage battery 14.

As described in the above cases A to C, transfer of electric power occurs in a case where one of two charger/dischargers that are the electric-vehicle charger/discharger 1 and the storage-battery charger/discharger 3 performs a charging operation and the other one performs a discharging operation.

In the charge/discharge system 101 according to the present embodiment, the electric-vehicle charger/discharger 1 executes control described below, thereby preventing occurrence of transfer of electric power described in the above cases A, B, and C. Specifically, in a case where a device connected to the electric-vehicle charger/discharger 1 includes a storage battery and charges the storage battery, the electric-vehicle charger/discharger 1 overcomes a problem of transfer of electric power between storage batteries. Therefore, it is important for the electric-vehicle charger/discharger 1 to grasp whether the device connected thereto is a device that only performs discharging, such as a power conditioner, or a device that performs both charging and discharging, such as a charger/discharger. In a case where only a device that only performs discharging, not a charger/discharger, is connected, the problem described in the above cases A, B, and C does not occur.

In the following descriptions, as in FIGS. 4 and 5, a current that flows between the storage battery 10 for power and the electric-vehicle charger/discharger 1 is represented by I₁, and a current consumed by the household load 4 is represented by I₂. Further, a current that flows between the storage-battery charger/discharger 3 and the power line 201 is represented by I₃, and a current supplied from the system power supply 5 is represented by I₄. The current I₃ is detected by the current sensor 27, and the current I₄ is detected by the current sensors 15 and 16. It is assumed that the values of the currents I₁ to I₄ are positive values if a current flows in a direction of the arrows in FIGS. 4 and 5.

First, a method is described in which the electric-vehicle charger/discharger 1 according to the present embodiment determines whether another device connected to the power line 201 is a device that performs a charging operation.

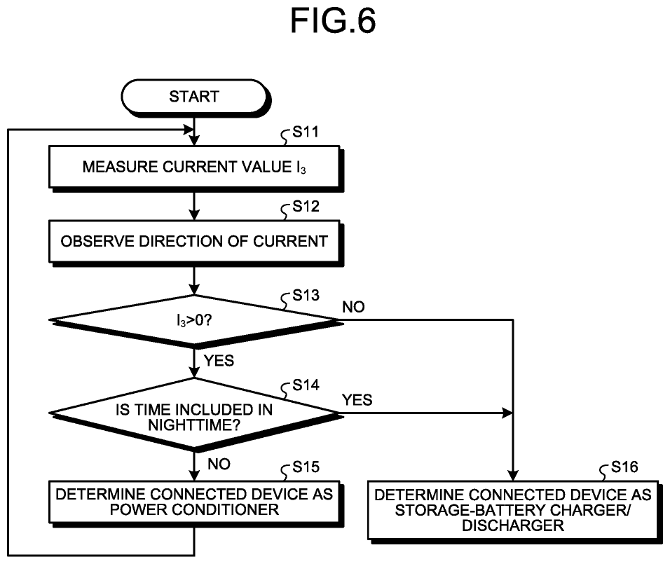

FIG. 6 is a flowchart illustrating an operation example of determining another device connected to the power line 201 performed by the electric-vehicle charger/discharger 1 according to the first embodiment.

In a case of determining the other device connected to the power line 201, the electric-vehicle charger/discharger 1 measures the current value I₃ that is a value of a current flowing between the other device and the power line 201, by the current sensor 27 (Step S11). The current detection unit 91 illustrated in FIG. 3 acquires a measurement result of the current value I₃ from the current sensor 27. The electric-vehicle charger/discharger 1 then observes a direction of a current flowing through the current sensor 27 (Step S12). Specifically, the electric-vehicle charger/discharger 1 determines the direction of the current based on whether the current value I₃ is a positive value or a negative value. If the current value I₃ is negative (NO at Step S13), a charging current flows to the other device. Therefore, the electric-vehicle charger/discharger 1 determines the other device as the storage-battery charger/discharger 3 that also performs a charging operation (Step S16). Meanwhile, if the current value I₃ is positive (YES at Step S13), a discharged current flows from the other device, and it is therefore necessary to determine whether discharging of a power conditioner occurs or discharging of a storage battery occurs. In this case, the electric-vehicle charger/discharger 1 determines whether the other device is a power conditioner based on a measured time of the current value I₃, that is, a present time. Specifically, the electric-vehicle charger/discharger 1 checks whether the measured time of the current value I₃ is included in the nighttime in which the sun does not appear. If the measured time is included in the nighttime (YES at Step S14), it is determined that the other device is the storage-battery charger/discharger 3 (Step S16). If the measured time of the current value I₃ is included in the daytime (NO at Step S14), it is determined that the other device is a power conditioner (Step S15). If the measured time of the current value I₃ is included in the daytime, it is likely that the electric-vehicle charger/discharger 1 determines the storage-battery charger/discharger 3 as a power conditioner. Therefore, when the electric-vehicle charger/discharger 1 determines that the other device is a power conditioner, the electric-vehicle charger/discharger 1 returns to Step S11 and continues its operation, and thus determination accuracy can be improved by continuing the operation. When the current value I₃=0, the electric-vehicle charger/discharger 1 may determine that the other device is not connected and return to Step S11.

The method of determining whether another device connected to the power line 201 is the storage-battery charger/discharger 3 is not limited to the method described above. When connecting the storage-battery charger/discharger 3, a user or a contractor may register whether the other device is the storage-battery charger/discharger 3 in advance, for example, by using the display 17 of the electric-vehicle charger/discharger 1.

Next, an operation of the electric-vehicle charger/discharger 1 is described, which prevents occurrence of transfer of electric power between the storage battery 10 for power and the storage battery 14. Descriptions are separately made to each of a charging operation and a discharging operation of the electric-vehicle charger/discharger 1.

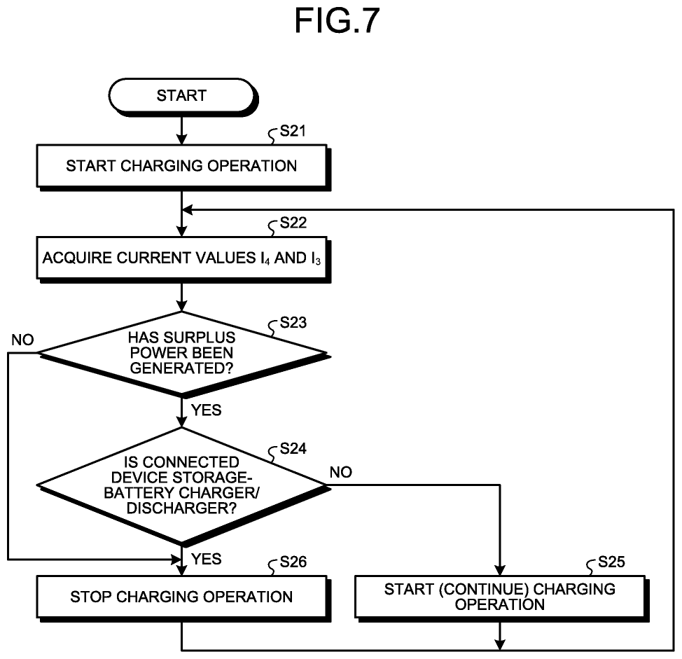

FIG. 7 is a flowchart illustrating an example of a charge control operation of the electric-vehicle charger/discharger 1 according to the first embodiment. The electric-vehicle charger/discharger 1 performs the operations illustrated in FIG. 7, thereby preventing transfer of electric power in the cases A and B described above, that is, from the storage battery 14 to the storage battery 10 for power as illustrated in FIG. 4.

Upon reception of a charge-start operation for the storage battery 10 for power, the electric-vehicle charger/discharger 1 starts the charge control operation illustrated in FIG. 7. A case corresponding to the above case A is described here. That is, a case is described in which the electric-vehicle charger/discharger 1 operates in a minimum electricity-buying mode and performs charging if surplus power has been generated, and the storage-battery charger/discharger 3 performs a discharging operation in a minimum electricity-buying mode.

Upon reception of the charge-start operation, the electric-vehicle charger/discharger 1 starts a charging operation (Step S21) and acquires the current value I₄ and the current value I₃ (Step S22). Specifically, the current detection unit 91 of the microcomputer 9 acquires the current value I₄ and the current value I₃.

The electric-vehicle charger/discharger 1 then checks whether surplus power has been generated (Step S23). At Step S23, the control unit 93 of the microcomputer 9 determines that there is surplus power, if the current value I₄<0, for example. The control unit 93 may determine that there is no surplus power if the current value I₃≤0.

If no surplus power has been generated (NO at Step S23), the electric-vehicle charger/discharger 1 stops the charging operation for the storage battery 10 for power (Step S26). That is, the control unit 93 of the microcomputer 9 controls the converter 7 and the inverter 8 not to charge the storage battery 10 for power. Thereafter, the electric-vehicle charger/discharger 1 returns to Step S22. If surplus power has been generated (YES at Step S23), the electric-vehicle charger/discharger 1 checks whether a connected device that is another device connected to the power line 201 is the storage-battery charger/discharger 3 (Step S24). At Step S24, the control unit 93 of the microcomputer 9 determines whether the connected device is the storage-battery charger/discharger 3, for example, based on the current value I₃ in an identical manner to that described referring to FIG. 6. Although the current value I₃ is acquired at Step S22 described above, the current value I₃ may be acquired after determination that surplus power has been generated.

If the connected device is the storage-battery charger/discharger 3 (YES at Step S24), the electric-vehicle charger/discharger 1 stops the charging operation for the storage battery 10 for power (Step S26) and returns to Step S22.

If the connected device is not the storage-battery charger/discharger 3 (NO at Step S24), the electric-vehicle charger/discharger 1 starts the charging operation for the storage battery 10 for power (Step S25). That is, the control unit 93 of the microcomputer 9 controls the converter 7 and the inverter 8 to charge the storage battery 10 for power. At this time, the electric-vehicle charger/discharger 1 charges the storage battery 10 for power with surplus power. After Step S25, the electric-vehicle charger/discharger 1 returns to Step S22 and continues its operation. If the electric-vehicle charger/discharger 1 shifts from Step S24 to Step S25 while performing the charging operation, it continues the charging operation. If the electric-vehicle charger/discharger 1 returns to Step S22 via Step S25 after determining that the connected device is not the storage-battery charger/discharger 3, it may only determine whether surplus power has been generated at Step S23 without performing Step S24 in which the connected device is determined.

While the case corresponding to the above case A has been described, operations in a case corresponding to the case B are also basically identical. However, in the case B, the electric-vehicle charger/discharger 1 performs the charging operation regardless of whether there is surplus power, and therefore shifts to Step S24 without performing Step S23 in which it is checked whether surplus power has been generated. If it is determined that the connected device is the storage-battery charger/discharger 3 at Step S24, the electric-vehicle charger/discharger 1 shifts to Step S26 where it stops the charging operation, and returns to Step S22.

Although the electric-vehicle charger/discharger 1 returns to Step S22 after Step S26 in the flowchart illustrated in FIG. 7, it may cause the display 17 to display that charging of the storage battery 10 for power is not performed to notify a user of the contents. The notified contents are such that charging of the storage battery 10 for power is not performed, the reason why charging is not performed, and the like. Further, the electric-vehicle charger/discharger 1 may display a way of enabling the storage battery 10 for power to be charged on the display 17. For example, the electric-vehicle charger/discharger 1 notifies a user to cut off the storage-battery charger/discharger 3 from the power line 201 by displaying the contents on the display 17.

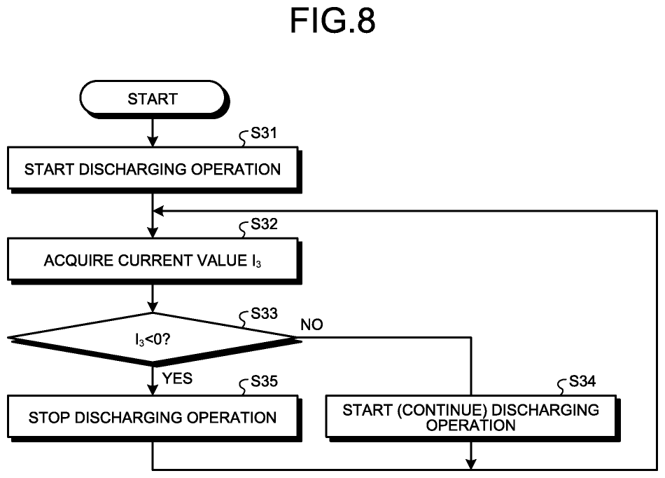

FIG. 8 is a flowchart illustrating an example of a discharge control operation of the electric-vehicle charger/discharger 1 according to the first embodiment. The electric-vehicle charger/discharger 1 performs the operations illustrated in FIG. 8, thereby preventing transfer of electric power in the above case C, that is, from the storage battery 10 for power to the storage battery 14 as illustrated in FIG. 5.

Upon reception of a discharge-start operation for the storage battery 10 for power, the electric-vehicle charger/discharger 1 starts the charge control operation illustrated in FIG. 8. A case corresponding to the above case C is described here. That is, a case is described in which the electric-vehicle charger/discharger 1 performs a discharging operation in a minimum electricity-buying mode, and the storage-battery charger/discharger 3 performs a charging operation in a forced charging mode.

Upon reception of the discharge-start operation, the electric-vehicle charger/discharger 1 starts the discharging operation (Step S31) and acquires the current value I₃ (Step S32). Specifically, the current detection unit 91 of the microcomputer 9 acquires the current value I₃.

The electric-vehicle charger/discharger 1 then checks whether the storage battery 14 is being charged, that is, the current value I₃ is less than 0 (Step S33). At Step S33, the control unit 93 of the microcomputer 9 checks whether the current value I₃<0 is established.

If the storage battery 14 is not being charged (NO at Step S33), the electric-vehicle charger/discharger 1 starts the discharging operation to discharge the storage battery 10 for power (Step S34). That is, the control unit 93 of the microcomputer 9 controls the converter 7 and the inverter 8 to discharge the storage battery 10 for power. If the electric-vehicle charger/discharger 1 shifts from Step S33 to Step S34 while performing the discharging operation, it continues the discharging operation. After Step S34, the electric-vehicle charger/discharger 1 returns to Step S32 and continues its operation.

Meanwhile, if the storage battery 14 is being charged (YES at Step S33), the electric-vehicle charger/discharger 1 stops the discharging operation (Step S35). That is, the control unit 93 of the microcomputer 9 controls the converter 7 and the inverter 8 to stop discharging of the storage battery 10 for power. After Step S35, the electric-vehicle charger/discharger 1 returns to Step S32 and continues its operation.

Although the electric-vehicle charger/discharger 1 returns to Step S32 after Step S35 in the flowchart illustrated in FIG. 8, it may cause the display 17 to display that discharging of the storage battery 10 for power is not performed to notify a user of the contents. The notified contents are such that discharging of the storage battery 10 for power is not performed, the reason why discharging is not performed, and the like. Further, the electric-vehicle charger/discharger 1 may display a way of enabling the storage battery 10 for power to be discharged on the display 17. For example, the electric-vehicle charger/discharger 1 notifies a user to cut off the storage-battery charger/discharger 3 from the power line 201 by displaying the contents on the display 17.

As described above, the electric-vehicle charger/discharger 1 according to the present embodiment controls a charging operation and a discharging operation for the storage battery 10 for power based on a current that flows between another device connected to the power line 201 and the household load 4. Specifically, in a case of charging the storage battery 10 for power, the electric-vehicle charger/discharger 1 determines whether the other device connected to the power line 201 is the storage-battery charger/discharger 3 based on the current that flows between the other device and the household load 4, and stops the charging operation for the storage battery 10 for power if the other device is the storage-battery charger/discharger 3. Further, in a case of discharging the storage battery 10 for power and supplying electric power to the household load 4, the electric-vehicle charger/discharger 1 determines whether the other device connected to the power line 201 is being charged based on the current that flows between the other device and the household load 4, and stops the discharging operation for the storage battery 10 for power if the other device is being charged. Therefore, it is possible to prevent charging of the storage battery 10 for power and discharging of the storage battery 14 from being performed simultaneously, thereby preventing transfer of electric power stored in the storage battery 14 to the storage battery 10 for power. Further, it is possible to prevent discharging of the storage battery 10 for power and charging of the storage battery 14 from being performed simultaneously, thereby preventing transfer of electric power stored in the storage battery 10 for power to the storage battery 14. Therefore, according to the electric-vehicle charger/discharger 1, it is possible to suppress loss of electric power caused by occurrence of transfer of electric power between the storage battery 10 for power incorporated in the electric vehicle 2 and the stationary storage battery 14.

In addition, it is possible to prevent occurrence of transfer of electric power without preparing a separate controller for executing control outside the electric-vehicle charger/discharger 1 by setting the type of another device connected to an electric circuit between the electric-vehicle charger/discharger 1 and the system power supply 5 (whether the other device is a charger/discharger or a discharging device) in the microcomputer 9 of the electric-vehicle charger/discharger 1 and executing control in accordance with a measurement result of a current sensor connected to an electric circuit of an input/output of the other device. Further, even if the type of the other device connected to the electric circuit between the electric-vehicle charger/discharger 1 and the system power supply 5 is not set or is incorrectly set or even if there is no unit that performs such setting, it is possible to infer the other device that is connected based on a detection value of a current, so that useless transfer of electric power can be prevented.

Although the electric-vehicle charger/discharger 1 performs determination of the type of the other device connected to the power line 201 and check of an operation state of the other device based on a value of a current that flows through the electric-power line 202, and controls a charging operation and a discharging operation in the present embodiment, identical operations may be performed by the storage-battery charger/discharger 3. That is, the storage-battery charger/discharger 3 may be configured to perform the operations described above in place of the electric-vehicle charger/discharger 1. In this case, a current sensor is provided between the electric-vehicle charger/discharger 1 and the power line 201, and the storage-battery charger/discharger 3 detects a current that flows between the electric-vehicle charger/discharger 1 and the power line 201.

### Second Embodiment

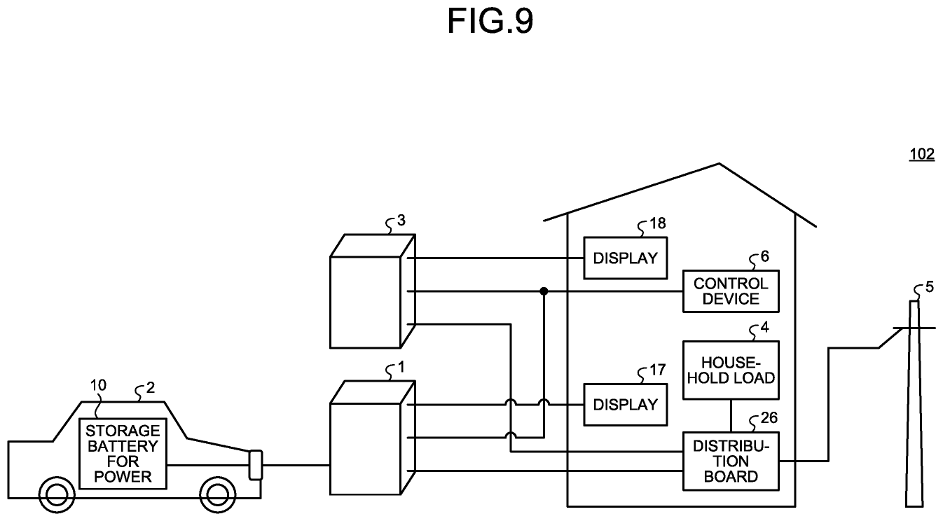

FIG. 9 is a diagram schematically illustrating a configuration example of a charge/discharge system according to a second embodiment. In FIG. 9, constituent elements identical to those of the first embodiment are denoted by like reference signs. In the present embodiment, parts different from the first embodiment are described.

A charge/discharge system 102 according to the second embodiment illustrated in FIG. 9 has a configuration in which a control device 6 is added to the charge/discharge system 101 according to the first embodiment. The control device 6 is connected to the electric-vehicle charger/discharger 1 and the storage-battery charger/discharger 3.

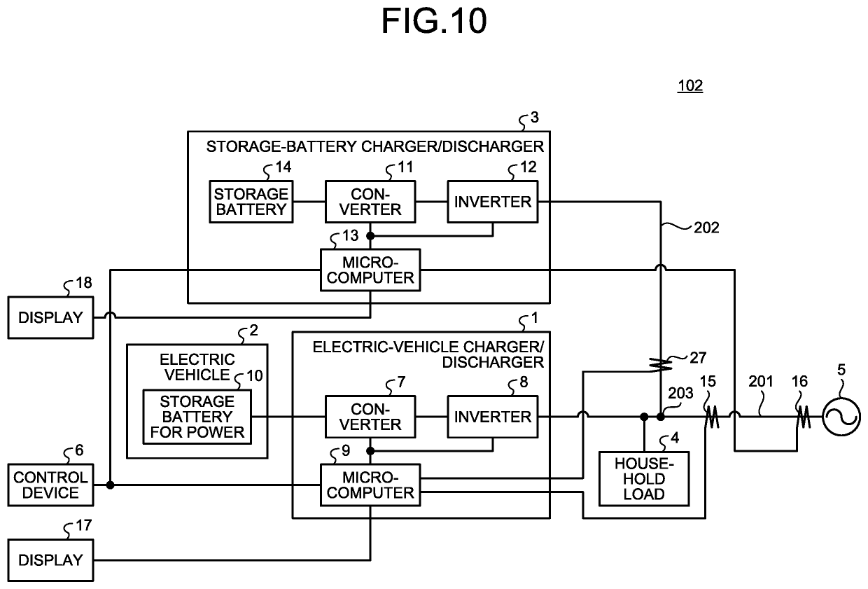

FIG. 10 is a diagram illustrating a configuration example of the charge/discharge system 102 according to the second embodiment. Among the respective constituent elements illustrated in FIG. 10, constituent elements identical to those illustrated in FIG. 9 are denoted by like reference signs. In FIG. 10, illustrations of the distribution board 26 illustrated in FIG. 9 are omitted.

As illustrated in FIG. 10, the control device 6 is connected to the microcomputer 9 of the electric-vehicle charger/discharger 1 and the microcomputer 13 of the storage-battery charger/discharger 3.

As described above, in the charge/discharge system 101 according to the first embodiment, the microcomputer 9 of the electric-vehicle charger/discharger 1 detects a charging/discharging state of the storage-battery charger/discharger 3 and an electricity-buying state of the system power supply 5, and controls a charging operation and a discharging operation of the electric-vehicle charger/discharger 1. Meanwhile, in the charge/discharge system 102 according to the present embodiment, the control device 6 controls operations of the electric-vehicle charger/discharger 1 and the storage-battery charger/discharger 3 to prevent transfer of electric power between the storage battery 10 for power and the storage battery 14. The control device 6 is constituted by a microprocessor that is identical to the microcomputer 9 of the electric-vehicle charger/discharger 1, a memory such as a RAM (Random Access Memory) and a ROM (Read Only Memory), a communication circuit for performing communication with the electric-vehicle charger/discharger 1 and the storage-battery charger/discharger 3, and the like.

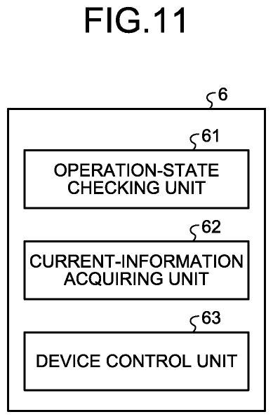

FIG. 11 is a diagram illustrating a functional configuration example of the control device 6 that constitutes the charge/discharge system 102 according to the second embodiment. The control device 6 includes an operation-state checking unit 61, a current-information acquiring unit 62, and a device control unit 63.

The operation-state checking unit 61 checks operation states of the electric-vehicle charger/discharger 1 and the storage-battery charger/discharger 3. The current-information acquiring unit 62 acquires current information indicating current values detected by the electric-vehicle charger/discharger 1 and the storage-battery charger/discharger 3 from the electric-vehicle charger/discharger 1 and the storage-battery charger/discharger 3. The device control unit 63 controls operations of the electric-vehicle charger/discharger 1 and the storage-battery charger/discharger 3.

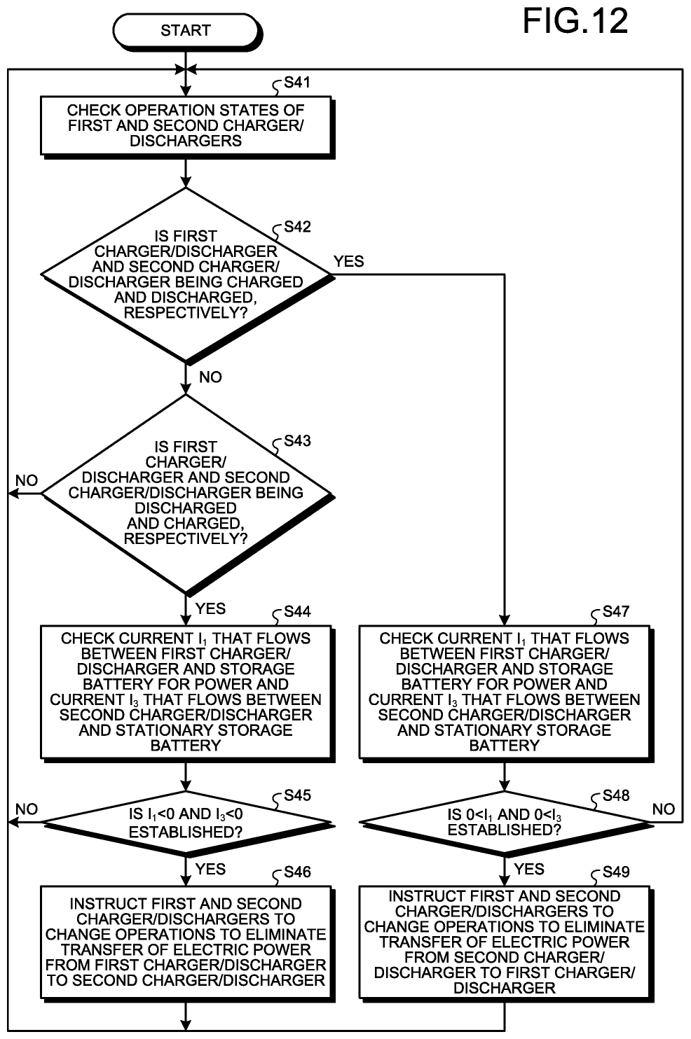

Next, an operation of the control device 6 is described. FIG. 12 is a flowchart illustrating an operation example of the control device 6 that constitutes the charge/discharge system 102 according to the second embodiment. In the following descriptions and FIG. 12, the electric-vehicle charger/discharger 1 is described as a first charger/discharger, and the storage-battery charger/discharger 3 is described as a second charger/discharger.

When starting an operation, the control device 6 checks operation states of the first charger/discharger (the electric-vehicle charger/discharger 1) and the second charger/discharger (the storage-battery charger/discharger 3) (Step S41). Specifically, the operation-state checking unit 61 of the control device 6 inquires of the electric-vehicle charger/discharger 1 and the storage-battery charger/discharger 3 the operation states thereof, and acquires information indicating the operation states from the electric-vehicle charger/discharger 1 and the storage-battery charger/discharger 3.

The control device 6 then checks whether a present state corresponds to a state where the first charger/discharger is being charged and the second charger/discharger is being discharged (Step S42). If the present state does not correspond to the state where the first charger/discharger is being charged and the second charger/discharger is being discharged (NO at Step S42), the control device 6 checks whether the present state corresponds to a state where the first charger/discharger is being discharged and the second charger/discharger is being charged (Step S43). The checking processes at Steps S42 and S43 are performed by the device control unit 63 of the control device 6.

If the present state does not correspond to the state where the first charger/discharger is being discharged and the second charger/discharger is being charged (NO at Step S43), the control device 6 returns to Step S41 and continues its operation.

If the present state corresponds to the state where the first charger/discharger is being discharged and the second charger/discharger is being charged (YES at Step S43), the control device 6 checks the current I₁ that flows between the first charger/discharger and a storage battery for power and the current I₃ that flows between the second charger/discharger and a stationary storage battery (Step S44). The current I₁ that flows between the first charger/discharger and the storage battery for power is a current that flows between the electric-vehicle charger/discharger 1 and the storage battery 10 for power. The current I₃ that flows between the second charger/discharger and the stationary storage battery is a current that flows between the converter 11 of the storage-battery charger/discharger 3 and the storage battery 14, and this current is equal to a current that flows between the storage-battery charger/discharger 3 and the power line 201. At Step S44, the current-information acquiring unit 62 inquires of the electric-vehicle charger/discharger 1 that is the first charger/discharger a value of the current I₁ and a value of the current I₃, and acquires first current information indicating the value of the current I₁ and second current information indicating the value of the current I₃. The checking of the value of the current I₁ and the value of the current I₃ is performed by the device control unit 63. The current-information acquiring unit 62 may acquire the second current information from the storage-battery charger/discharger 3 that is the second charger/discharger.

The control device 6 then checks whether both the current I₁ and the current I₃ are negative values, that is, “I₁<0 and I₃<0” (Step S45). The checking process at Step S45 is performed by the device control unit 63 of the control device 6. If “I₁<0 and I₃<0” is not established (NO at Step S45), the control device 6 returns to Step S41 and continues its operation.

If “I₁<0 and I₃<0” is established (YES at Step S45), the control device 6 instructs the first charger/discharger and the second charger/discharger to change the operations thereof to eliminate transfer of electric power from the first charger/discharger to the second charger/discharger (Step S46). A case where “I₁<0 and I₃<0” is established is a state where the first charger/discharger performs a discharging operation, the second charger/discharger performs a charging operation, and electric power is transferred from the first charger/discharger to the second charger/discharger, that is, a state where electric power is transferred from the storage battery 10 for power to the storage battery 14. Therefore, the device control unit 63 of the control device 6 instructs the first charger/discharger to stop the discharging operation or instructs the second charger/discharger to stop the charging operation. The device control unit 63 may instruct the first charger/discharger to stop the discharging operation and instruct the second charger/discharger to stop the charging operation at the same time. By performing Step S46 by the control device 6, the operation state of at least one of the first and second charger/dischargers is changed, so that the state where electric power is transferred from the first charger/discharger to the second charger/discharger is eliminated. After performing Step S46, the control device 6 returns to Step S41 and continues its operation.

Meanwhile, if the present state corresponds to the state where the first charger/discharger is being charged and the second charger/discharger is being discharged (YES at Step S42), the control device 6 checks the current I₁ that flows between the first charger/discharger and the storage battery for power and the current I₃ that flows between the second charger/discharger and the stationary storage battery (Step S47). The process at Step S47 is identical to that at Step S44 described above.

The control device 6 then checks whether both the current I₁ and the current I₃ are positive values, that is, “0<I₁ and 0<I₃” (Step S48). The checking process at Step S48 is performed by the device control unit 63 of the control device 6. If “0<I₁ and 0<I₃” is not established (NO at Step S48), the control device 6 returns to Step S41 and continues its operation.

If “0<I₁ and 0<I₃” is established (YES at Step S48), the control device 6 instructs the first charger/discharger and the second charger/discharger to change the operations thereof to eliminate transfer of electric power from the second charger/discharger to the first charger/discharger (Step S49). A case where “0<I₁ and 0<I₃” is established is a state where the first charger/discharger performs a charging operation, the second charger/discharger performs a discharging operation, and electric power is transferred from the second charger/discharger to the first charger/discharger, that is, a state where electric power is transferred from the storage battery 14 to the storage battery 10 for power. Therefore, the device control unit 63 of the control device 6 instructs the first charger/discharger to stop the charging operation or instructs the second charger/discharger to stop the discharging operation. The device control unit 63 may instruct the first charger/discharger to stop the charging operation and instruct the second charger/discharger to stop the discharging operation at the same time. By performing Step S49 by the control device 6, the operation state of at least one of the first and second charger/dischargers is changed, so that the state where electric power is transferred from the second charger/discharger to the first charger/discharger is eliminated. After performing Step S49, the control device 6 returns to Step S41 and continues its operation.

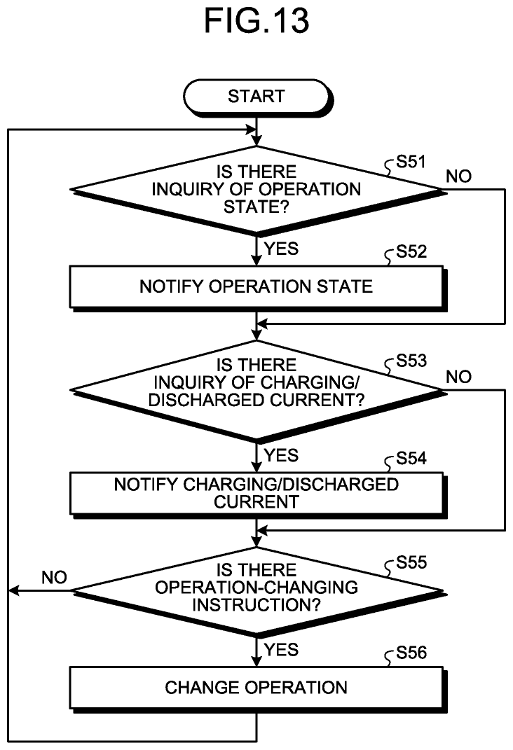

FIG. 13 is a flowchart illustrating an operation example of the electric-vehicle charger/discharger 1 according to the second embodiment.

The electric-vehicle charger/discharger 1 according to the second embodiment checks whether there is an inquiry of an operation state from the control device 6 (Step S51) and, if there is the inquiry of an operation state (YES at Step S51), notifies the control device 6 of the operation state (Step S52). In this case, the electric-vehicle charger/discharger 1 notifies the control device 6 whether the electric-vehicle charger/discharger 1 is performing a charging operation, is performing a discharging operation, or is performing neither the charging operation nor the discharging operation.

If there is no inquiry of the operation state from the control device 6 (NO at Step S51) and when Step S52 is performed, the electric-vehicle charger/discharger 1 checks whether there is an inquiry of a charging/discharged current from the control device 6 (Step S53). The inquiry of a charging/discharged current is an inquiry of the values of the currents I₁ and I₃. If there is the inquiry of the charging/discharged current (YES at Step S53), the electric-vehicle charger/discharger 1 notifies the control device 6 of the charging/discharged current (the value of the current I₁ and the value of the current I₃) (Step S54).

If there is no inquiry of the charging/discharged current from the control device 6 (NO at Step S53) and when Step S54 is performed, the electric-vehicle charger/discharger 1 checks whether there is an operation-changing instruction from the control device 6 (Step S55). The operation-changing instruction is an instruction of stopping a charging operation or an instruction of stopping a discharging operation. If there is the operation-changing instruction (YES at Step S55), the electric-vehicle charger/discharger 1 changes its operation in accordance with the instruction contents (Step S56). If there is no operation-changing instruction (NO at Step S55) and when Step 56 is performed, the electric-vehicle charger/discharger 1 returns to Step S51 and continues its operation.

While the operations of the electric-vehicle charger/discharger 1 have been described, the operations of the storage-battery charger/discharger 3 are operations obtained by omitting Steps S53 and S54 from the flowchart illustrated in FIG. 13, that is, operations in which the storage-battery charger/discharger 3 shifts to Step S55 when Step S52 are performed and when a determination result at Step S51 is NO.

As described above, the charge/discharge system 102 according to the present embodiment includes the control device 6 that controls two charge/discharger that are the electric-vehicle charger/discharger 1 and the storage-battery charger/discharger 3. The control device 6 checks an operation state of each charger/discharger and, if a present state is an operation state where electric power is transferred from one of the charger/discharger to the other one, instructs at least one charger/discharger to change its operation. Therefore, the state where electric power is transferred from one charge/discharger to the other one is eliminated, so that it is possible to suppress generation of loss of electric power caused by transfer of electric power between storage batteries connected to the respective charger/dischargers.

Further, the charge/discharge system 102 according to the present embodiment is provided with the control device 6 outside the electric-vehicle charger/discharger 1 and the storage-battery charger/discharger 3, and the control device 6 collects input/output currents of each charger/discharger from the charger/discharger. Therefore, it is not necessary for each charger/discharger to measure a current that flows between the other charger/discharger and the power line 201.

While there has been described the configuration in the present embodiment in which the control device 6 inquires of the electric-vehicle charger/discharger 1 charging/discharged currents (I₁, I₃) of the electric-vehicle charger/discharger 1 and the storage-battery charger/discharger 3, a configuration in which the inquiry is made to the storage-battery charger/discharger 3 may be employed. In this case, a current sensor is provided for detecting a current that flows between the electric-vehicle charger/discharger 1 and the power line 201, in place of the current sensor 27, and the microcomputer 13 of the storage-battery charger/discharger 3 acquires the current value (I₁) detected by this current sensor.

In the first and second embodiments, there has been described a case where the number of storage-battery charger/dischargers that are the second charger/dischargers connected to the power line 201 is one. However, even in a case where a plurality of storage-battery charger/dischargers are connected the power line 201, it is also possible to suppress generation of loss caused by transfer of electric power.

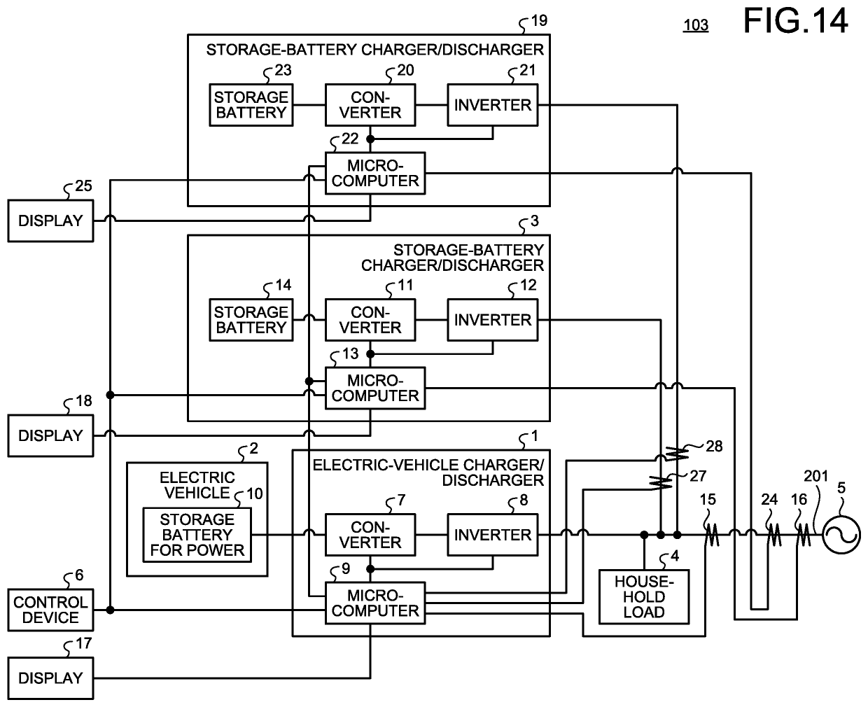

As in a charge/discharge system 103 illustrated in FIG. 14, for example, a configuration may be employed in which two second charger/dischargers (storage-battery charger/dischargers 3 and 19) are connected to the power line 201. FIG. 14 is a diagram illustrating a modification of the charge/discharge system according to the second embodiment. The storage-battery charger/discharger 19 has an identical configuration and identical functions to the storage-battery charger/discharger 3. That is, a converter 20, an inverter 21, a microcomputer 22, and a storage battery 23 of the storage-battery charger/discharger 19 are identical to the converter 11, the inverter 12, the microcomputer 13, and the storage battery 14 of the storage-battery charger/discharger 3, respectively. A display 25 connected to the microcomputer 22 is identical to the display 18 connected to the microcomputer 13 of the storage-battery charger/discharger 3. The microcomputer 22 acquires a value of a current that flows between the system power supply 5 and the household load 4 from a current sensor 24.

Further, a current sensor 28 is provided on an electric-power line that connects the power line 201 and the storage-battery charger/discharger 19, and the microcomputer 9 of the electric-vehicle charger/discharger 1 acquires a value of a current that flows between the power line 201 and the storage-battery charger/discharger 19 from the current sensor 28.

In the charge/discharge system 103 illustrated in FIG. 14, the control device 6 inquires of respective charger/dischargers (the electric-vehicle charger/discharger 1 and the storage-battery charger/dischargers 3 and 19) the operation states thereof or inquires of the electric-vehicle charger/discharger 1 a charging/discharged current of each charger/discharger. In a state where transfer of electric power occurs between the charger/dischargers, the control device 6 instructs one or more of the charger/dischargers to change operations thereof, thereby eliminating the state where transfer of electric power occurs.

Further, in a configuration in which the control device 6 is omitted from the charge/discharge system 103 illustrated in FIG. 14, the electric-vehicle charger/discharger 1 acquires electric-power values from the current sensors 15, 27, and 28, and recognizes states of currents that flow through the storage-battery charger/dischargers 3 and 19, thereby determining whether a present state is a state where transfer of electric power occurs between the electric-vehicle charger/discharger 1 and each of the storage-battery charger/dischargers 3 and 19. If the present state is the state where transfer of electric power occurs, the electric-vehicle charger/discharger 1 changes the operation thereof (that is, of the electric-vehicle charger/discharger 1), that is, stops a charging operation during the charging operation and stops a discharging operation during the discharging operation, thereby eliminating the state where transfer of electric power occurs.

As described above, even in a case where there are a plurality of storage-battery charger/dischargers that constitute a charge/discharge system, it is possible to prevent transfer of electric power between an electric-vehicle charger/discharger and a storage-battery charger/discharger and suppress loss of electric power by performing the operations described in the first or second embodiment.

The configurations described in the above embodiments are only examples of the content of the present invention. The configurations can be combined with other well-known techniques, and part of each of the configurations can be omitted or modified without departing from the scope of the present invention.

### REFERENCE SIGNS LIST

1 electric-vehicle charger/discharger, 2 electric vehicle, 3, 19 storage-battery charger/discharger, household load, 5 system power supply, 6 control device, 7, 11, 20 converter, 8, 12, 21 inverter, 9, 13, microcomputer, 10 storage battery for power, 14, 23 storage battery, 15, 16, 24, 27, 28 current sensor, 17, 18, display, 26 distribution board, 61 operation-state checking unit, 62 current-information acquiring unit, 63 device control unit, 91 current detection unit, 92 connected-device determination unit, 93 control unit, 101, 102, 103 charge/discharge system, 201 power line, 202 electric-power line, 203 connecting point.

1. A charge/discharge device to constitute a charge/discharge system together with a storage-battery charger/discharger that performs an operation of charging a stationary storage battery installed in a house and an operation of discharging the stationary storage battery to supply electric power to a load, and to perform an operation of charging a storage battery for power included in an electric vehicle and a discharging operation of discharging the storage battery for power to supply electric power to the load, the charge/discharge device comprising:
a current detection circuit to detect a value of a current that flows between the stationary storage battery and the load; and
a control circuit to control the operation of charging the storage battery for power and the operation of discharging the storage battery for power based on a value of a current detected by the current detection circuit, wherein the control circuit determines whether transfer of electric power occurs between the storage battery for power and the stationary storage battery based on the value of the current, and changes an operation of the charge/discharge device when transfer of the electric power occurs.

2. (canceled)

3. The charge/discharge device according to claim 1, wherein the control circuit stops a charging operation when transfer of the electric power occurs and the charge/discharge device is performing a charging operation, and stops a discharging operation when transfer of the electric power occurs and the charge/discharge device is performing the discharge operation.

4. The charge/discharge device according to claim 1, further comprising a user interface circuit to notify a user of an operation state of the charge/discharge device.

5. The charge/discharge device according to claim 4, wherein the user interface circuit receives input of information indicating whether the storage-battery charger/discharger is connected to a power line to which the load and the charge/discharge device are connected.

6. The charge/discharge device according to claim 1, further comprising a connected-device determination circuit to determine whether the storage-battery charger/discharger is connected to a power line to which the load and the charge/discharge device are connected based on the value of the current.

7. A charge/discharge system comprising:
a first charger/discharger to perform an operation of charging a storage battery for power included in an electric vehicle and a discharging operation of discharging the storage battery for power to supply electric power to a load;
a second charger/discharger to perform an operation of charging a stationary storage battery installed in a house and an operation of discharging the stationary storage battery to supply electric power to the load; and
a control circuit to control the first charger/discharger and the second charger/discharger, wherein
the control circuit includes
an operation-state checking circuit to check an operation state of the first charger/discharger and an operation state of the second charger/discharger,
a current-information acquiring circuit to acquire, when one of the first charger/discharger and the second charger/discharger is performing a charging operation and the other one is performing a discharging operation, first current information indicating a value of a current that flows between the first charger/discharger and the storage battery for power and second current information indicating a value of a current that flows between the stationary storage battery and the load; and
a device control circuit to determine whether transfer of electric power occurs between the storage battery for power and the stationary storage battery based on the first current information and the second current information, and to instruct one or both of the first charger/discharger and the second charger/discharger to change an operation thereof when transfer of the electric power occurs.

8. The charge/discharge device according to claim 3, further comprising a user interface circuit to notify a user of an operation state of the charge/discharge device.

9. The charge/discharge device according to claim 8, wherein the user interface circuit receives input of information indicating whether the storage-battery charger/discharger is connected to a power line to which the load and the charge/discharge device are connected.

10. The charge/discharge device according to claim 3, further comprising a connected-device determination circuit to determine whether the storage-battery charger/discharger is connected to a power line to which the load and the charge/discharge device are connected based on the value of the current.

11. The charge/discharge device according to claim 4, further comprising a connected-device determination circuit to determine whether the storage-battery charger/discharger is connected to a power line to which the load and the charge/discharge device are connected based on the value of the current.

12. The charge/discharge device according to claim 8, further comprising a connected-device determination circuit to determine whether the storage-battery charger/discharger is connected to a power line to which the load and the charge/discharge device are connected based on the value of the current.
